(19) United States
(12) Patent Application Publication
(10) Pub. No.: US 2024/0223988 A1
(43) Pub. Date: Jul. 4, 2024

(54) SOUND GENERATION DEVICE, SOUND GENERATION METHOD, AND PROGRAM

(71) Applicant: Sony Interactive Entertainment Inc., Tokyo (JP)

(72) Inventors: Shunsuke Saito, Tokyo (JP); Nicholas Ward-Foxton, London (GB)

(73) Assignee: Sony Interactive Entertainment Inc., Tokyo (JP)

(21) Appl. No.: 18/577,874

(22) PCT Filed: Jun. 15, 2022
(86) PCT No.: PCT/JP2022/023880

§ 371 Date: Jan. 9, 2024

(30) Foreign Application Priority Data
Jul. 16, 2021 (JP) 2021-118176

(51) Int. Cl. H04S 7/00; A63F 13/25; G02B 27/01; G06F 3/01

(52) U.S. Cl. CPC H04S 7/303; A63F 13/25; G02B 27/0176; G06F 3/012

(57) ABSTRACT

An acquisition section acquires a position and a rotation of a head portion of a user. A sound source data generation section generates sound source data on the basis of the position and the rotation acquired at a first time while a predetermined position is set as an origin of a three-dimensional coordinate system of a virtual space. A correction processing section applies correction processing including at least any one of a translation and a rotation of the virtual sound source in the virtual space to the sound source data at the first time on the basis of differences of the position and the rotation at the first time from the updated position and rotation at a second time after the first time. A sound generation section generates a sound to be rendered through use of the sound source data to which the correction processing has been applied.

### TECHNICAL FIELD

The present disclosure relates to a device, a method, and a program which generate and correct a sound.

### BACKGROUND ART

Game play is executed while a head-mounted display (hereinafter sometimes referred to as HMD) connected to a game machine is worn on a head portion, a screen displayed on the HMD is being viewed, and a controller or the like is operated. In a case of a display of a stationary type connected to the game machine, a view field range of a user extends also to an outside of a screen of the display, and hence the user cannot concentrate on the screen of the display or a sense of immersion into the game may lack. In this respect, when the user wears the head-mounted display, the user views nothing but video displayed on the HMD, the sense of immersion into a video world increases, and an effect of further increasing entertainment property is provided.

Moreover, when a virtual space across 360 degrees is displayed as the user wearing the HMD rotates the head portion, the sense of immersion into the video further increases, and operability of an application such as the game also increases. At this time, a sound is generated in association with the motion of the head portion of the user.

### SUMMARY

### Technical Problem

In a case in which the head tracking function is imparted to the HMD as described above to generate the sound in association with the motion of the head portion of the user, latency exists from the generation to output of the sound. Thus, there is a case in which a deviation occurs between a direction of the head portion of the user assumed at a sound generation time and a direction of the head portion of the user at a time when the sound is actually output. Due to this deviation of the sound, the user may feel a sense of discomfort.

The present disclosure has been made in view of the problem mentioned above and has an object of providing a sound generation device and a sound generation method capable of providing a corrected sound reduced in latency from generation to output of the sound.

### Solution to Problem

In order to solve the problem described above, a sound generation device of an aspect of the present disclosure includes an acquisition section that acquires at least any one of a position and a rotation of a head portion of a user, a sound source data generation section that generates, on the basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space, a correction processing section that receives, from the acquisition section, at least any one of the position and the rotation updated at a second time after the first time and applies correction processing including at least any one of a translation and a rotation of the virtual sound source in the virtual space to the sound source data at the first time on the basis of a difference of at least any one of the position and the rotation at the first time from at least any one of the updated position and rotation, and a sound generation section that generates a sound to be rendered through use of the sound source data to which the correction processing has been applied.

A sound generation device of another aspect of the present disclosure includes an acquisition section that acquires at least any one of a position and a rotation of a head portion of a user, a sound source data generation section that generates, on the basis of at least any one of the position and the rotation acquired at a first time, sound source data being ambisonics data in which a virtual sound source is represented through use of a spherical harmonic function in a virtual space having a predetermined position of the user as a center, a correction processing section that receives, from the acquisition section, at least any one of the position and the rotation updated at a second time after the first time and applies correction processing including at least any one of a translation and a rotation of the virtual sound source in the virtual space to the sound source data at the first time on the basis of a difference of at least any one of the position and the rotation at the first time from at least any one of the updated position and rotation, and a sound generation section that generates a sound to be rendered through use of the sound source data to which the correction processing has been applied.

A sound generation method of another aspect of the present disclosure includes a step of acquiring at least any one of a position and a rotation of a head portion of a user, a step of generating, on the basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space, a step of receiving at least any one of the position and the rotation updated at a second time after the first time, a step of applying correction processing including at least any one of a translation and a rotation of the virtual sound source in the virtual space to the sound source data at the first time on the basis of a difference of at least any one of the position and the rotation at the first time from at least any one of the updated position and rotation, and a step of generating a sound to be rendered through use of the sound source data to which the correction processing has been applied.

A sound generation method of still another aspect of the present disclosure includes a step of acquiring at least any one of a position and a rotation of a head portion of a user, a step of generating, on the basis of at least any one of the position and the rotation acquired at a first time, sound source data being ambisonics data in which a virtual sound source is represented through use of a spherical harmonic function in a virtual space having a predetermined position of the user as a center, a step of receiving at least any one of the position and the rotation updated at a second time after the first time, a step of applying correction processing including at least any one of a translation and a rotation of the virtual sound source in the virtual space to the sound source data at the first time on the basis of a difference of at least any one of the position and the rotation at the first time from at least any one of the updated position and rotation, and a step of generating a sound to be rendered through use of the sound source data to which the correction processing has been applied.

A program of still another aspect of the present disclosure causes a computer to execute a step of generating, on the basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space, a step of receiving at least any one of the position and the rotation updated at a second time after the first time, a step of applying correction processing including at least any one of a translation and a rotation of the virtual sound source in the virtual space to the sound source data at the first time on the basis of a difference of at least any one of the position and the rotation at the first time from at least any one of the updated position and rotation, and a step of generating a sound to be rendered through use of the sound source data to which the correction processing has been applied.

A program of still another aspect of the present disclosure causes a computer to execute a step of acquiring at least any one of a position and a rotation of a head portion of a user, a step of generating, on the basis of at least any one of the position and the rotation acquired at a first time, sound source data being ambisonics data in which a virtual sound source is represented through use of a spherical harmonic function in a virtual space having a predetermined position of the user as a center, a step of receiving at least any one of the position and the rotation updated at a second time after the first time, a step of applying correction processing including at least any one of a translation and a rotation of the virtual sound source in the virtual space to the sound source data at the first time on the basis of a difference of at least any one of the position and the rotation at the first time from at least any one of the updated position and rotation, and a step of generating a sound to be rendered through use of the sound source data to which the correction processing has been applied.

Note that a result of conversion of any combination of components and an expression of the present disclosure described above among a method, a device, a system, a computer program, a data structure, a recording medium, and the like is also effective as an aspect of the present disclosure.

### Advantageous Effect of Invention

According to the present disclosure, there can be provided a corrected sound reduced in latency from the generation to the display of the sound.

### BRIEF DESCRIPTION OF DRAWINGS

FIG. 1 is an exterior view of a head-mounted display.

FIG. 2 is a functional configuration diagram of the head-mounted display.

FIG. 3 is a configuration diagram of a sound generation system according to an embodiment.

FIG. 4 is a functional configuration diagram of a sound generation device according to the embodiment.

FIG. 5 is a diagram for describing sounds output in the head-mounted display.

FIG. 6 is a sequence diagram of conventional sound generation processing without correction processing.

FIG. 7 is a sequence diagram of the sound generation processing with the correction processing of the embodiment.

FIG. 8 is a flowchart of the sound generation processing with the correction processing of the embodiment.

FIG. 9 is a diagram for describing the sound correction processing of the first embodiment.

FIG. 10 is a diagram for describing the sound correction processing of a second embodiment.

### DESCRIPTION OF EMBODIMENTS

### First Embodiment

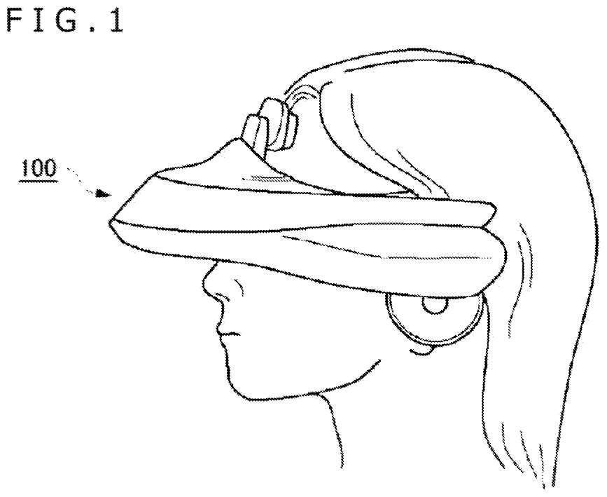

FIG. 1 is an exterior view of an HMD 100. The HMD 100 is a device worn on a head portion of a user to watch a still image, a moving image, and the like appearing on a display and to listen to sounds, music, and the like output from a headphone. Position information relating to the user can be measured by a position sensor such as a GPS (Global Positioning System) integrated into or externally mounted to the HMD 100. Moreover, posture information such as a rotation angle and an inclination of the head portion of the user wearing the HMD 100 can be measured through use of a posture sensor integrated into or externally mounted to the HMD 100.

The HMD 100 of the present embodiment is an example of a sound provision device which provides sounds to the user. However, the sound provision device is not limited to the HMD and may be a headphone, a headset (a headphone with a microphone), an earphone, an earring, and the like.

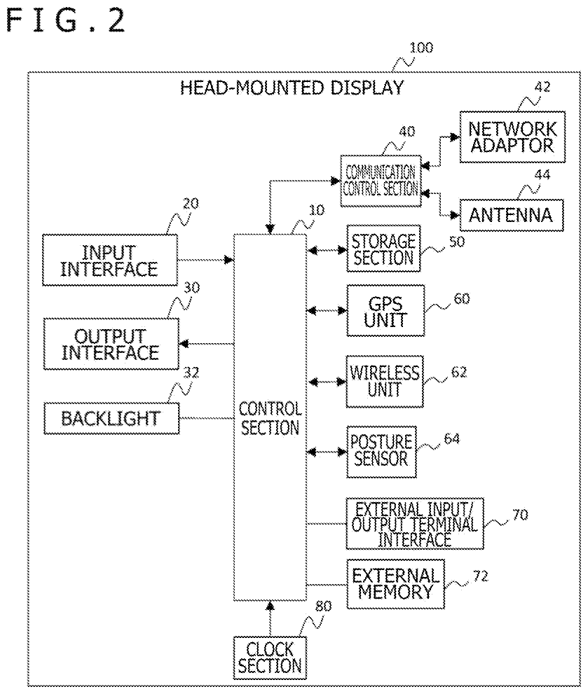

FIG. 2 is a functional configuration diagram of the HMD 100 of the present embodiment. A control section 10 is a main processor which processes a signal such as an image signal and a sensor signal, an instruction, and data and outputs processed signal, instruction, and data. An input interface 20 receives an operation signal and a setting signal from a touch panel and a touch panel controller and provides the operation signal and the setting signal to the control section 10. An output interface 30 receives the image signal from the control section 10 and causes the display to display the image signal. The output interface 30 receives a sound signal from the control section 10 and causes speakers to output sounds of the sound signal.

A communication control section 40 transmits data input from the control section 10 to the outside through wired or wireless communication via a network adaptor 42 or an antenna 44. Moreover, the communication control section 40 receives data from the outside through wired or wireless communication via the network adaptor 42 or the antenna 44 and outputs the received data to the control section 10.

A storage section 50 temporarily stores data, parameters, the operation signal, and the like to be processed by the control section 10.

A GPS unit 60 receives the position information from the GPS satellites in accordance with the operation signal from the control section 10 and supplies the position information to the control section 10. A wireless unit 62 receives the position information from a wireless base station in accordance with the operation signal from the control section 10 and supplies the position information to the control section 10.

A posture sensor 64 detects posture information such as a rotation angle and an inclination of a body portion 110 of the HMD 100. The posture sensor 64 is implemented by appropriately combining a gyro sensor, an acceleration sensor, an angular acceleration sensor, and the like.

An external input/output terminal interface 70 is an interface for connecting a peripheral device such as a USB (Universal Serial Bus) controller. An external memory 72 is an external memory such as a flash memory.

A clock section 80 sets time information through use of the setting signal from the control section 10 and supplies time data to the control section 10.

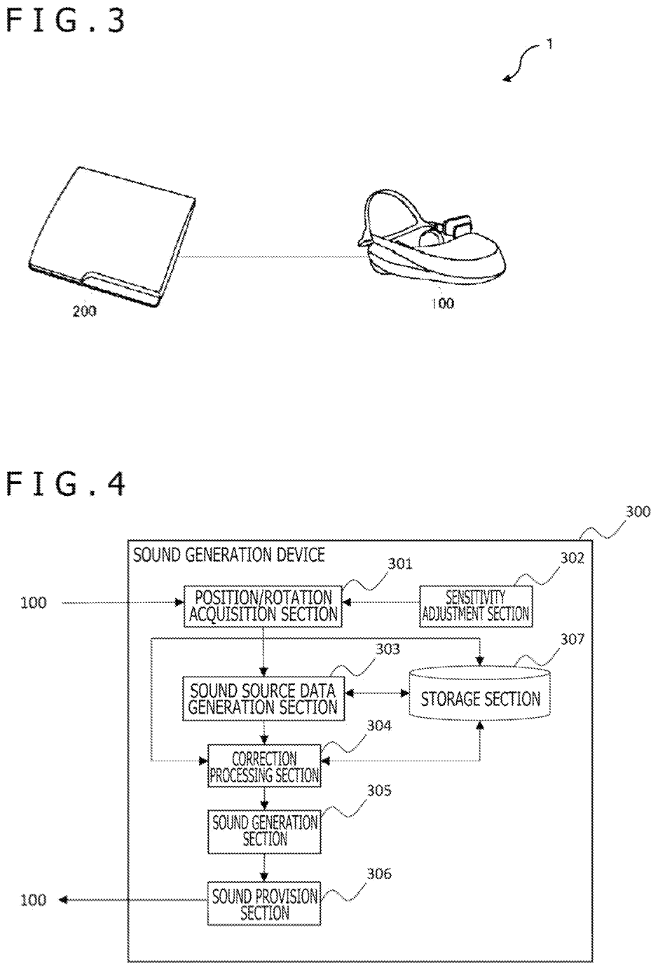

FIG. 3 is a configuration diagram of a sound generation system of the present embodiment. The sound generation system 1 includes the HMD 100 and a rendering device 200. The HMD 100 is connected to the rendering device 200 through the wireless communication or the interface for connecting the peripheral device such as the USB. The rendering device 200 of the present embodiment is a game machine. The rendering device 200 may further be connected to a server via a network. In that case, the server may provide, to the rendering device 200, an online application such as a game in which multiple users can participate via the network. The HMD 100 may be connected to a computer or a portable terminal in place of the rendering device 200.

The rendering device 200 basically processes a program of content, generates sounds, and transmits the sounds to the HMD 100. The program and data of the content are read, by a media drive (not illustrated), from a ROM (Read-Only Memory) medium (not illustrated) which records application software such as a game and license information of the content. This ROM medium is a read-only recording medium such as an optical disc, a magneto-optical disk, and a blue-ray disc. The rendering device 200 in an aspect generates sounds of the content at a predetermined rate according to the position and the posture of the head portion of the user wearing the HMD 100.

FIG. 4 is a functional configuration diagram of the sound generation device 300 according to the present embodiment. This drawing depicts the block diagram focusing on functions, and these functions can be implemented in various forms such as only hardware, only software, or a combination thereof.

The sound generation device 300 includes a position/rotation acquisition section 301, a sensitivity adjustment section 302, a sound source data generation section 303, a correction processing section 304, a sound generation section 305, a sound provision section 306, and a storage section 307. In the present embodiment, the sound generation device 300 is implemented in the rendering device 200 to which the HMD 100 is connected. However, the configuration is not limited to this example, and at least a part of the functions of the sound generation device 300 may be implemented in the control section 10 of the HMD 100. In particular, a function of the correction processing section 304 described later may be implemented on the HMD 100 side. As another example, at least a part of the functions of the sound generation device 300 may be implemented in a server connected to the rendering device 200 via a network.

The position/rotation acquisition section 301 acquires the position and the rotation of the head portion of the user wearing the HMD 100 on the basis of the position information sensed by the GPS unit 60 and a motion sensor of the HMD 100 and the posture information sensed by the posture sensor 64. The position of the head portion of the user may be acquired by a camera of the rendering device 200 detecting a motion of the HMD 100. The position/rotation acquisition section 301 of the present embodiment is a part of an acquisition section.

The position/rotation acquisition section 301 acquires the position and the rotation of the head portion of the user on the basis of sensitivity instructed by the sensitivity adjustment section 302. For example, when the user rotates the head, a change in angle of the head portion of the user is detected by the posture sensor 64, and the sensitivity adjustment section 302 instructs the position/rotation acquisition section 301 to ignore the change in the detected angle until the change in angle exceeds a predetermined value.

As the motion sensor, a combination of at least one of a 3-axis geomagnetic sensor, a 3-axis acceleration sensor, and a 3-axis gyro (angular velocity) sensor may be used to detect front-rear, left-right, and up-down motions of the head portion of the user. Moreover, an accuracy of the detection of the motion of the head portion may be increased by combining the pieces of position information relating to the head portion of the user.

The sound source data generation section 303 arranges a sound object in a virtual space on the basis of at least any one of the position and the rotation acquired at a first time while a predetermined position of the user is set as an origin of a three-dimensional coordinate system of the virtual space. The sound source data generation section 303 generates sound source data indicating three-dimensional coordinates of the sound object arranged in the virtual space. The sound object of the present embodiment is an example of a virtual sound source. In this configuration, the predetermined position of the user can be a center of the head portion of the user, but is not limited to this example. The predetermined position of the user serving as the origin of the three-dimensional coordinate system of the virtual space may be a position of another portion such as the neck of the user. For example, the sound source data generation section 303 reads the three-dimensional coordinates of the sound object in the virtual space from the storage section 307 according to a scene, thereby arranging one or multiple sound objects in the virtual space. Moreover, the sound source data generation section 303 reads sound waveform data relating to each sound object according to the scene from the storage section 307. The sound source data generation section 303 provides the sound source data and the sound waveform data to the correction processing section 304.

The correction processing section 304 receives the position and the rotation of the HMD 100 updated at a second time after the first time from the position/rotation acquisition section 301. The correction processing section 304 applies correction processing including a translation and a rotation of the sound object in the virtual space to the sound source data at the first time on the basis of differences of the position and the rotation at the first time from the position and rotation updated at the second time. Details of this correction processing are described later. The correction processing section 304 provides, to the sound generation section 305, the sound source data to which the correction processing has been applied and the sound waveform data.

The sound generation section 305 uses the sound source data to which the correction processing has been applied and the sound waveform data to generate sounds to be rendered in the virtual space. For example, the sound generation section 305 executes binaural rendering on the basis of the sound source data to which the correction processing has been applied and the sound waveform data, thereby generating a sound heard by each of the left ear and the right ear of the user from each sound object. For example, the sound having a sound volume based on the sound waveform data is generated at a magnification according to a distance between the user and the sound object.

The sound provision section 306 provides the generated sounds to the HMD 100. As a result, the sounds are output from the HMD 100.

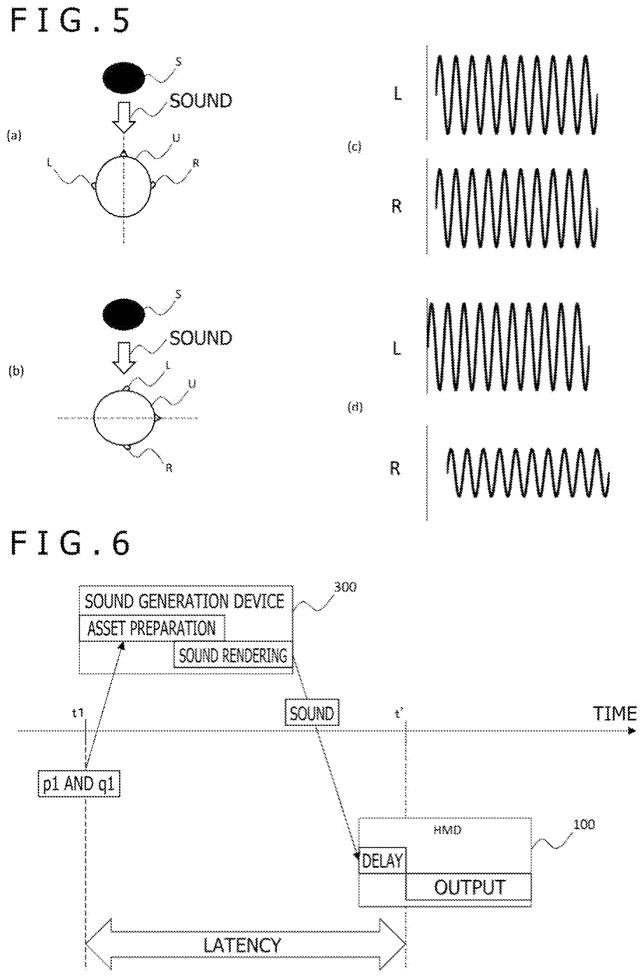

With reference to FIG. 5(a) to FIG. 5(d), a description is now given of the sounds which reach both the ears of the user in the virtual space. A description is given of the sounds output to the HMD 100. As illustrated in FIG. 5(a), in a case in which a user U faces a sound object S in the virtual space, the sounds from the sound object S reach from a front direction of the user U. At this time, as appreciated from waveform data of the sounds of FIG. 5(c), the sounds having substantially the same sound volume and delay reach the left ear L and the right ear R of the user U. Meanwhile, as illustrated in FIG. 5(b), in a case in which the user U faces a right direction, the sounds from the sound object S reach from the left direction of the user. At this time, as appreciated from waveform data relating to the sounds of FIG. 5(d), the delay of the sound at the left ear L of the user U is smaller than the delay of the sound at the right ear R, and the sound volume at the left ear L of the user U is larger than the sound volume at the right ear R.

A description is now given of a case in which the sounds are not corrected. Consideration is given of a case in which the user U takes 21.2 ms to turn the head from the state of FIG. 5(a) in which the user U is facing the sound object S to the state of FIG. 5(b) in which the user U is facing the right direction. In this case, the sounds of the waveform data of FIG. 5(c) in the state of FIG. 5(a) are generated. As a result, in a case in which an update frequency in the sound generation device 300 is 21.2 ms, the sounds of the waveform data of FIG. 5(c) reach the left ear L and the right ear R of the user U for the period of 21.2 ms from the state of facing the sound object S. On this occasion, the direction of the user U with respect to the sound object S changes by the user U turning the head to the right direction, and hence how the sounds from the sound object S are heard is to change as the direction changes in theory. However, the sounds are generated on the basis of the state of FIG. 5(a), and the user U hears the sounds of the waveform data of FIG. 5(c) which corresponds to the time before the change in direction of the user U. As a result, the user U may feel a sense of discomfort caused by a deviation of the direction due to the time difference. Similarly, not only in the case of the change in direction of the user U, but also in a case of a movement (a change in position) of the user U, the user U may feel the sense of discomfort caused by a deviation between the positions before and after the movement.

In the present embodiment, processing of correcting the sound source data is executed in order to eliminate the sense of discomfort caused by the deviations of the direction and position due to this time difference. For the sake of comparison, the conventional sound generation processing without the correction processing is first described with reference to FIG. 6, and then the correction processing of the present embodiment is described with reference to FIG. 7.

FIG. 6 is a sequence diagram for describing the conventional sound generation processing without the correction processing.

The sound generation device 300 prepares assets such as the arrangement of the sound objects and the generation of the sound source data and acquires a position p1 and a rotation q1 of the HMD 100 at a first time t1. In parallel with the asset preparation, processing of rendering the sounds at the position p1 and the rotation q1 at the first time t1 is executed. This sound rendering processing requires a certain processing time.

The sounds generated by the sound generation device 300 are supplied to the HMD 100. The HMD 100 and the sound generation device 300 are connected in a wired manner or a wireless manner, and the provision of the sounds from the sound generation device 300 to the HMD 100 requires a certain transmission time. In a case in which the sound generation device 300 and the HMD 100 are connected to each other via a network, a network delay occurs.

The HMD 100 acquires the sounds generated by the sound generation device 300 and executes output processing for the sounds. A delay occurs due to this output processing, and the sounds are output from the speakers at a time t′.

As described above, the certain time is required for the rendering processing, the sound transmission processing, and the output processing from the provision of the position p1 and the rotation q1 of the HMD 100 to the sound generation device 300 at the first time t1 to the output of the sounds from the speakers of the HMD 100 at the time t′, and latency occurs as illustrated in FIG. 6. The user wearing the HMD 100 moves and changes the posture also between the time t1 at which the position and the rotation of the HMD 100 are provided for the sound generation and the time t′ at which the sounds are output to the HMD 100. As a result, the user hears the sounds at the previous position and rotation of the HMD 100 by the time difference Δt=t′−t1, and hence there is a case in which the user feels the sense of discomfort due to the deviations between the position and the rotation which are assumed for the sounds to be output and the current position and rotation.

FIG. 7 is a sequence diagram for describing the sound generation processing with the correction processing of the present embodiment.

This sound generation processing is the same as the sound generation processing of FIG. 6 until the sound generation device 300 acquires the position p1 and the rotation q1 at the time t1 from the HMD 100 and prepares the assets. In the present embodiment, the sound generation device 300 applies the correction processing to the generated sound source data at a second time t2 at which the sound generation device 300 starts the sound rendering. This correction processing may be executed by any one of the HMD 100 and the sound generation device 300. In a case in which the HMD 100 has sufficient processing performance, the correction processing can be executed in the HMD 100 and, in a case in which the HMD 100 does not has the sufficient processing performance, the sound generation device 300 executes the correction processing and provides the sounds generated by the sound source data after the correction to the HMD 100.

In the correction processing, a position p2 and a rotation q2 of the HMD 100 at the second time t2 are acquired, and the sound source data is corrected on the basis of the deviations of the position and the rotation of the HMD 100 between the time t1 and the latest second time t2. The HMD 100 executes the output processing on the basis of the corrected sound source data and outputs the sounds from the speakers. As a result, the apparent latency is reduced to a difference between the second time t2 and the time t′ as illustrated in FIG. 7.

The correction processing of the present embodiment is now detailed, and technical items forming assumption are first described.

The sound generation section 305 defines a three-dimensional coordinate system serving as a reference of the position p and the rotation q of the HMD 100. This three-dimensional coordinate system is only required to be a cartesian coordinate system, and each axis may be selected to any direction. The origin of the three-dimensional coordinate system is the center of the head portion of the user, but may be a point other than the center of the head portion. For example, the three-dimensional coordinate system may be defined by asking the user wearing the HMD 100 at the start of the application such as a game to take a posture serving as a reference at a position serving as a reference and acquiring a reference position p0 and a reference rotation q0 of the HMD 100 from the sensor information relating to the HMD 100 at this time.

A description is now given of an overview of steps of generating the sounds output to the HMD 100 by the sound generation device 300 of the present embodiment.

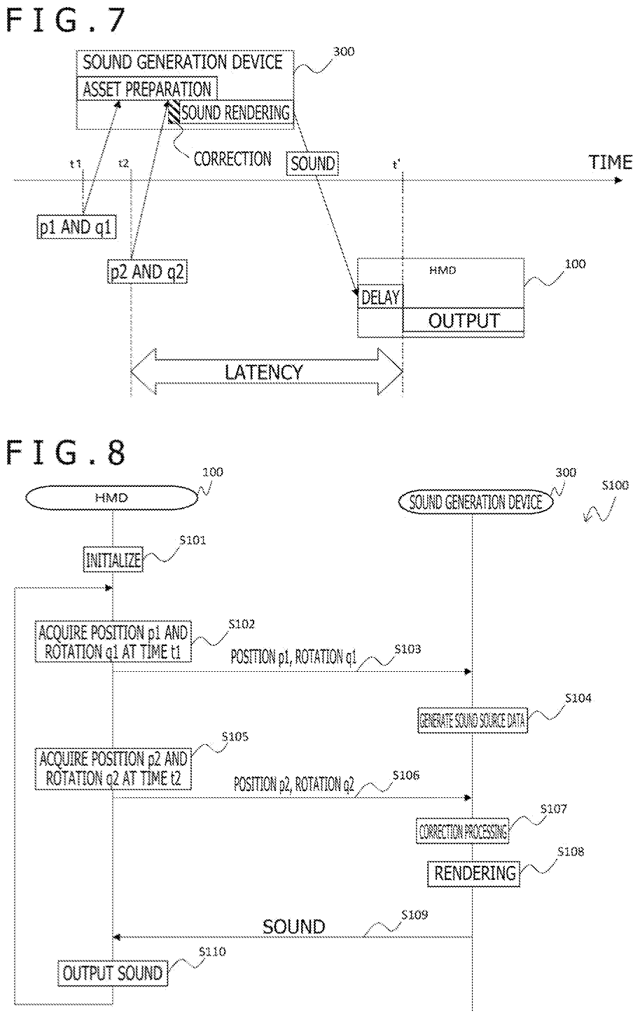

FIG. 8 is a flowchart for describing sound generation processing S100 by the sound generation device 300.

In Step S101, the HMD 100 defines the three-dimensional coordinate system serving as the reference as initialization processing. This is an operation for determining the position and rotation serving as the references of the motion of the HMD 100. The initial position p0 and the initial rotation q0 are acquired from the sensor information relating to the HMD 100 at the position instructed by the user and the three-dimensional coordinate system is defined while values thereof are considered as an origin (0, 0, 0).

In Step S102, the HMD 100 acquires the position p1 and the rotation q1 of the HMD 100 at the first time t1 from the sensor information relating to the HMD 100.

In Step S103, the HMD 100 provides the position p1 and the rotation q1 at the first time t1 to the sound generation device 300.

In Step S104, the sound generation device 300 generates the sound source data indicating the three-dimensional coordinates of the sound object arranged in the virtual space on the basis of the position p1 and the rotation q1 at the first time t1. Specifically, the position/rotation acquisition section 301 acquires the position p1 and the rotation q1 at the first time t1 from the HMD 100, provides the position p1 and the rotation q1 to the sound source data generation section 303, and causes the storage section 307 to store the position p1 and the rotation q1. The sound source data generation section 303 reads the three-dimensional coordinate data and the sound waveform data relating to each sound object according to the scene from the storage section 307. The sound source data generation section 303 arranges the sound object in the virtual space so as to correspond to the position p1 and the rotation q1 on the basis of the scene. The sound source data generation section 303 generates the sound source data indicating the three-dimensional coordinates of each sound object in the virtual space at the time t1 and provides the sound source data and the sound waveform data to the correction processing section 304.

After the generation of the sound source data at the first time t1 by the sound generation device 300 is completed, the HMD 100 acquires the position p2 and the rotation q2 of the HMD 100 at the second time t2 from the sensor information relating to the HMD 100 in Step S105.

In Step S106, the HMD 100 provides the position p2 and the rotation q2 at the second time t2 to the sound generation device 300. The user wearing the HMD 100 moves or changes the direction even while the sound generation device 300 is preparing the assets, and hence the position p2 and the rotation q2 of the HMD 100 at the second time t2 are slightly deviated from the position p1 and the rotation q1 at the time t1.

In Step S107, the sound generation device 300 executes the correction processing for the sound source data in order to absorb the deviations of the position and the rotation of the HMD 100 between the first time t1 and the second time t2. Specifically, the position/rotation acquisition section 301 acquires the position p2 and the rotation q2 updated at the latest second time t2 from the HMD 100 and provides the position p2 and the rotation q2 to the correction processing section 304. The correction processing section 304 further reads the position p1 and the rotation q1 of the HMD 100 at the first time t1 from the storage section 307. The correction processing section 304 calculates a difference p2−p1 in the position and a difference q2−q1 in the rotation of the position p1 and the rotation q1 at the first time t1 from the position p2 and the rotation q2 at the latest second time t2. The correction processing section 304 corrects the sound source data by translating the position of the three-dimensional coordinates of the sound object in the virtual space at the first time t1 by the difference p2−p1 and rotating the position thereof by the difference q2−q1. The correction processing section 304 supplies the sound source data after the correction and the sound waveform data to the sound provision section 306.

Even when the position and the rotation of the HMD 100 deviate between the first time t1 and the second time t2, the deviations due to the time difference can be absorbed by correcting the sound source data to adjust the three-dimensional coordinates of each sound object so as to match the latest position and rotation.

The correction processing by the correction processing section 304 is now detailed through use of equations. Input provided to the correction processing section 304 includes the sound source data generated for the position p1 and the rotation q1 of the HMD 100 at the first time t1, the position p1 and the q1 used when this sound source data is generated, and the updated position p2 and rotation q2 of the HMD 100 at the latest second time t2. The correction processing section 304 applies the following correction processing to the sound source data at the position p1 and the rotation q1 at the first time t1.

It is assumed that the sensor can provide information relating to a position and a rotation from an absolute reference of the HMD 100. As the sensor, the GPS unit 60 and the posture sensor 64 of the HMD 100 are used. Moreover, a motion controller (not illustrated) may be used as the sensor. The position p and the rotation q change according to the motion of the user wearing the HMD 100. The HMD 100 is a rigid body and hence is not a point, but the position p is defined as a position of one fixed point on the HMD 100. This one fixed point is hereinafter referred to as a center point of the HMD 100.

In a case in which the position of the HMD 100 at the first time t1 is p=(x, y, z) and the difference in the position of the HMD 100 between the first time t1 and the second time t2 is p′=(tₓ, t_{y}, t_{z}), the three-dimensional coordinates after the translation of the sound object are obtained as given by the following equation.

$$[ \begin{matrix}{x}^{′} \\ {y}^{′} \\ {z}^{′} \\ 1\end{matrix} ] = [ \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ] [ \begin{matrix}x \\ y \\ z \\ 1\end{matrix} ] \qquad [ Math . 1 ]$$

Moreover, in a case in which the difference in the rotation of the HMD 100 between the first time t1 and the second time t2 is q′=(qₐ, q_{b}, q_{c}, q_{d}), the three-dimensional coordinates after the rotation of the sound object are obtained as given by the following equation.

$$[ \begin{matrix}{x}^{′} \\ {y}^{′} \\ {z}^{′} \\ 1\end{matrix} ] = [ \begin{matrix}{q}_{a}^{2} + {q}_{b}^{2} - {q}_{c}^{2} - {q}_{d}^{2} & 2 ( {q}_{b} {q}_{c} - {q}_{a} {q}_{d} ) & 2 ( {q}_{b} {q}_{d} + {q}_{a} {q}_{c} ) & 0 \\ 2 ( {q}_{b} {q}_{c} + {q}_{a} {q}_{d} ) & {q}_{a}^{2} - {q}_{b}^{2} + {q}_{c}^{2} - {q}_{d}^{2} & 2 ( {q}_{c} {q}_{d} - {q}_{a} {q}_{b} ) & 0 \\ 2 ( {q}_{b} {q}_{d} - {q}_{a} {q}_{c} ) & 2 ( {q}_{c} {q}_{d} + {q}_{a} {q}_{b} ) & {q}_{a}^{2} - {q}_{b}^{2} - {q}_{c}^{2} + {q}_{d}^{2} & 0 \\ 0 & 0 & 0 & 1\end{matrix} ] [ \begin{matrix}x \\ y \\ z \\ 1\end{matrix} ] \qquad [ Math . 2 ]$$

A calculation method of the three-dimensional rotation and the like relating to computer graphics through use of the quaternion q is described in “Introduction to Quaternion for 3D Computer Graphics” (Kohgaku-Sha Co., Ltd., January 2004).

In Step S107, the sound generation device 300 uses the sound source data after the correction to render the sounds to be output to the speakers of the HMD 100. Specifically, the sound generation section 305 renders the sound heard by each of the left and right ears of the user from each sound object on the basis of the sound source data after the correction and the sound waveform data. The sound generation section 305 provides the rendered sounds to the sound provision section 306.

The sound rendered from the sound object having the translated and rotated three-dimensional coordinates as described above corresponds to the sound obtained by correcting the sound rendered for the position p1 and the rotation q1 at the first time t1 to the sound rendered for the position p2 and the rotation q2 at the second time t2. The sounds corresponding to the position p2 and the rotation q2 at the second time t2 can be rendered without processing such as the asset preparation by using the differences p2−p1 and q2−q1 between the first time t1 and the second time t2 to translate and rotate the three-dimensional coordinates of the sound object at the first time t1. As a result, the processing amount of the data is reduced, hence quick rendering can be achieved, and the delay time at the time of the generation of the sounds after the correction can be reduced.

In Step S108, the sound provision section 306 provides the rendered sounds to the HMD 100.

In Step S109, the sounds after the correction are output to the HMD 100. The user comes to hear the sounds corrected by the amounts of the deviations of the position and the rotation of the HMD 100 between the first time t1 and the second time t2, the latency corresponding to the time difference between the first time t1 and the second time t2 is absorbed, and the “sense of discomfort” felt by the user is reduced. After that, the sound generation processing S100 returns to Step S101, and the subsequent processing is repeated.

As described above, the sounds output from the HMD 100 can be corrected according to the motion of the head portion, hence the latency corresponding to the changes in the position and the direction of the head portion of the user decreases, and it is possible to more clearly recognize the relative position of the sound object to the user. As a result, it is possible to increase a sense of immersion into the virtual space.

In particular, in a game application, in a case in which the user uses a button of a game controller, a touch screen of the portable terminal, or the like to change the position and the direction in the virtual space, thereby interacting with a character of another user in the game, a real time property is an important element. In such a case, it is beneficial to impart the pseudo real time property by the correction processing.

### Modification Example

A description is now given of a modification example.

The data corresponding to one frame is read, thereby rendering the sounds in the embodiment, but data corresponding to multiple frames may be read, thereby rendering the sounds. For example, consideration is now given of a case in which data corresponding to four frames is read. When an update frequency of the sounds is 21.2 ms, sounds corresponding to 5.3 ms are generated in one frame. In a case in which the sound object is arranged at (0, 0, 2) in a state in which the user is directly facing the right direction (left-right, height, depth)=(1, 0, 0), the user hears the sounds of the sound object from (0, 0, 2). When the user takes 21.2 ms to face the front direction (0, 0, 1) from this state, the user hears the sounds of the sound object from (2, 0, 0) after 21.2 ms. In a case in which the correction processing described above is not executed in this state, although the user has changed the direction from the right direction to the front direction, the sounds of the sound object are heard from (0, 0, 2) in any one of the four frames. As a result, the user hears the sounds from the front (0, 0, 2) for 21.2 ms.

Meanwhile, in the present modification example, the newest position and rotation are acquired in every frame (that is, every 5.3 ms), and the position and the rotation are corrected for each frame on the basis of the position and the rotation in each frame. As a result, the user hears the sounds of the sound object from (0, 0, 2)->(1, 0, √3)->(√3, 0, 1)->(2, 0, 0) every 5.3 ms. As a result, the sounds from the sound object are more smoothly heard.

In the first embodiment, the correction processing for the sound source data is executed on the basis of the difference in each of the position and the rotation, but the configuration is not limited to this example. The position/rotation acquisition section 301 may acquire at least any one of the position and the rotation and the correction processing section 304 may execute the correction processing for the sound source data on the basis of the difference in at least any one of the position and the rotation.

### Second Embodiment

A description is now given of a second embodiment of the present disclosure. In the description of the second embodiment, a description redundant with that in the first embodiment is appropriately omitted, and a description is given while focusing on configurations different from those in the first embodiment.

In the second embodiment, the sound generation section 305 generates sounds to be rendered at a first frequency. The correction processing section 304 receives the position and the rotation updated at the second time from the position/rotation acquisition section 301 at a second frequency matching sound processing granularity which indicates a processing amount of the sound data per unit time of the HMD 100. The correction processing section 304 applies the correction processing for multiple times to any one of the sound source data generated by the sound generation section 305 and the sound source data to which the correction processing has been applied, on the basis of multiple updated positions and rotations received at the second frequency higher than the first frequency.

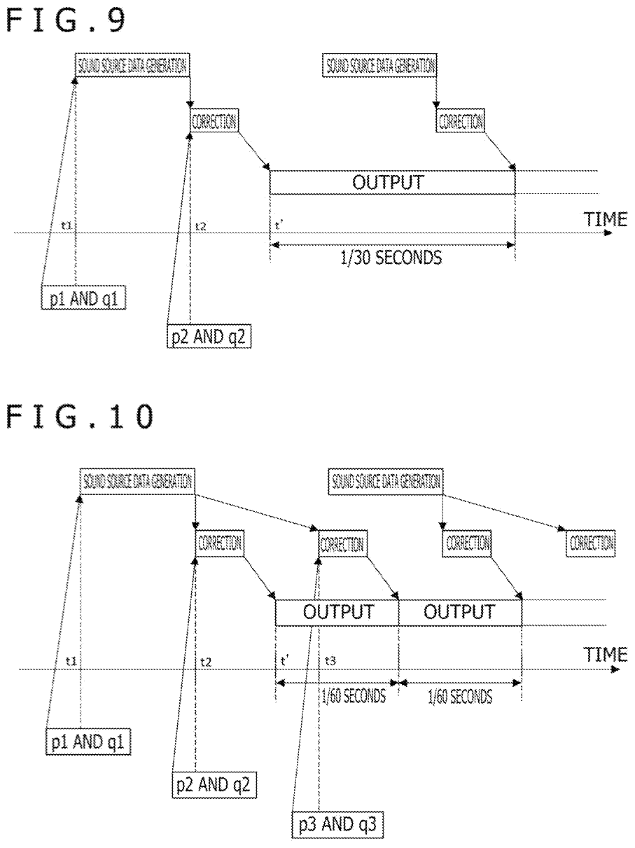

With reference to FIG. 9 and FIG. 10, a description is now given of the correction processing of the second embodiment. FIG. 9 is a diagram for describing the sound correction processing of the first embodiment for the sake of comparison. As illustrated in FIG. 9, the sound generation device 300 receives the position p1 and the rotation q1 of the HMD 100 at the time t1 and starts the generation of the sound source data. The sound generation device 300 uses the newest position p2 and rotation q2 of the HMD 100 at the second time t2 to execute the correction processing for the sound source data. When the sound processing granularity of the HMD 100 is 30 frames/second, the sound generation device 300 generates the frame (sounds), executes the correction processing, and provides the sounds after correction, to the HMD 100 at 30 frames/second. Note that the correction processing may be executed on the HMD 100 side.

FIG. 10 is a diagram for describing the sound correction processing in the second embodiment. While the sound processing granularity of the rendering by the sound generation device 300 is 30 frames/second, the sound processing granularity of the HMD 100 is a higher frame rate. For example, in a case in which the sound processing granularity of the HMD 100 is 60 frames/second, the frequency of the correction processing is increased so as to match the sound processing granularity of the HMD 100 in the second embodiment.

As illustrated in FIG. 10, the sound generation device 300 uses the position p2 and the rotation q2 of the HMD 100 at the second time t2 to apply first correction processing to the sound source data at the time t1 and uses the sound source data after the correction to output the sounds from the HMD 100. After that, the sound generation device 300 uses a position p3 and a rotation q3 of the HMD 100 at a third time t3 to apply second correction processing to the same sound source data and uses the sound source data after the second correction to output the sounds from the HMD 100. As a result, even when the sound processing granularity of the sound generation device 300 is 30 frames/second, the sound after the correction is output at 60 frames/second. As described above, the sound processing granularity can be increased or reduced by executing the correction processing at a predetermined frequency, and hence it is possible to impart a function of sound processing granularity conversion to the system particularly in a case in which the sound generation device 300 and the HMD 100 are different from each other in sound processing granularity.

In the description of FIG. 10, the first correction processing through use of the position p2 and the rotation q2 at the second time t2 and the second correction processing through use of the position p3 and the rotation q3 at the third time t3 are applied to the same sound source data generated by the sound generation device 300. As another method, the second correction processing may be applied to the sound source data after the correction generated by the first correction processing.

As described above, according to the first embodiment and the second embodiment, it is possible to absorb the time difference of the sound output time from the sound generation time, thereby being able to reduce the apparent latency by using the position and the rotation of the user at the sound output time to correct the sound source data generated while assuming the position and the rotation of the user at the sound generation time.

### Third Embodiment

A description is now given of a third embodiment of the present disclosure. In the description of the second embodiment, a description redundant with that in the first embodiment is appropriately omitted, and a description is given while focusing on configurations different from those in the first embodiment.

The correction processing is applied to the sound source data using the sound object having the position coordinates in the first embodiment, but the configuration is not limited to this example. In the third embodiment, the correction processing is applied to sound source data which uses ambisonics data.

In the third embodiment, the sound source data generation section 303 generates, as the sound source data, the ambisonics data in which a virtual sound source is represented through use of a spherical harmonic function in a virtual space on the basis of the position and rotation acquired at the first time. Specifically, the sound source data generation section 303 reads the sound waveform data in the virtual space from the storage section 307 according to the scene and applies the spherical harmonic function to the read sound waveform data, thereby generating the ambisonics data. The sound source data generation section 303 supplies the generated ambisonics data to the correction processing section 304.

The correction processing section 304 applies the correction processing to the ambisonics data through the method described above. Details of the correction processing is similar to the correction processing of the first embodiment, and hence a description thereof is omitted. The correction processing section 304 supplies the ambisonics data to which the correction processing has been applied to the sound generation section 305. The sound generation section 305 uses the ambisonics data to which the correction processing has been applied to render the sounds and supplies the rendered sounds to the sound provision section 306. The sound provision section 306 supplies the rendered sounds to the HMD 100, thereby enabling the user to experience the sounds through use of the ambisonics via the HMD 100.

A description has been given of the present disclosure on the basis of the embodiments. The embodiments are illustrative, and it is to be understood by those who are skilled in the art that changes and variations may be made in the combinations of the components and the processing processes thereof and these changes and variations are also within the scope of the present disclosure. Such modification examples are described.

### INDUSTRIAL APPLICABILITY

The present disclosure relates to a device, a method, and a program which generate and correct a sound.

### REFERENCE SIGNS LIST

1: Sound generation system
10: Control section
20: Input interface
30: Output interface
32: Backlight
40: Communication control section
42: Network adaptor
44: Antenna
50: Storage section
60: GPS unit
62: Wireless unit
64: Posture sensor
70: External input/output terminal interface
72: External memory
80: Clock section
100: Head-mounted display
200: Rendering device
300: Sound generation device
301: Position/rotation acquisition section 301
302: Sensitivity adjustment section
303: Sound source data generation section
304: Correction processing section
305: Sound generation section
306: Sound provision section
307: Storage section

1. A sound generation device comprising:
an acquisition section that acquires at least any one of a position and a rotation of a head portion of a user;
a sound source data generation section that generates, on a basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space;
a correction processing section that receives, from the acquisition section, at least any one of the position and the rotation updated at a second time after the first time and applies correction processing including at least any one of a translation and a rotation of the virtual sound source in the virtual space to the sound source data at the first time on a basis of a difference of at least any one of the position and the rotation at the first time from at least any one of the updated position and rotation; and
a sound generation section that generates a sound to be rendered through use of the sound source data to which the correction processing has been applied.

2. The sound generation device according to claim 1, wherein the correction processing section executes the correction processing including at least any one of the translation and the rotation of each of the multiple virtual sound sources arranged in the virtual space on a basis of the difference for each of the multiple virtual sound sources.

3. A sound generation device comprising:
an acquisition section that acquires at least any one of a position and a rotation of a head portion of a user;
a sound source data generation section that generates, on a basis of at least any one of the position and the rotation acquired at a first time, sound source data being ambisonics data in which a virtual sound source is represented through use of a spherical harmonic function in a virtual space having a predetermined position of the user as a center;
a correction processing section that receives, from the acquisition section, at least any one of the position and the rotation updated at a second time after the first time and applies correction processing including at least any one of a translation and a rotation of the virtual sound source in the virtual space to the sound source data at the first time on a basis of a difference of at least any one of the position and the rotation at the first time from at least any one of the updated position and rotation; and
a sound generation section that generates a sound to be rendered through use of the sound source data to which the correction processing has been applied.

4. The sound generation device according to claim 1, wherein:
the sound generation section generates the sound to be rendered at a first frequency, and
the correction processing section receives the updated position and rotation from the acquisition section at a second frequency matching a sound processing granularity of a sound providing device that provides the corrected sound to the user, and applies the correction processing for multiple times to any one of the sound source data and the sound source data to which the correction processing has been applied on a basis of the multiple updated positions and received rotations at the second frequency higher than the first frequency.

5. A sound generation method comprising:
acquiring at least any one of a position and a rotation of a head portion of a user;
generating, on a basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space;
receiving at least any one of the position and the rotation updated at a second time after the first time;
applying correction processing including at least any one of a translation and a rotation of the virtual sound source in the virtual space to the sound source data at the first time on a basis of a difference of at least any one of the position and the rotation at the first time from at least any one of the updated position and rotation; and
generating a sound to be rendered through use of the sound source data to which the correction processing has been applied.

6. A non-transitory, computer-readable storage medium containing a computer program, which when executed by a computer, causes the computer to perform a sound generation method, comprising:
acquiring at least any one of a position and a rotation of a head portion of a user;
generating, on a basis of at least any one of the position and the rotation acquired at a first time, sound source data indicating three-dimensional coordinates of a virtual sound source arranged in a virtual space while a predetermined position of the user is set as an origin of a three-dimensional coordinate system of the virtual space;
receiving at least any one of the position and the rotation updated at a second time after the first time;
applying correction processing including at least any one of a translation and a rotation of the virtual sound source in the virtual space to the sound source data at the first time on a basis of a difference of at least any one of the position and the rotation at the first time from at least any one of the updated position and rotation; and
generating a sound to be rendered through use of the sound source data to which the correction processing has been applied.

7. A sound generation method comprising:
acquiring at least any one of a position and a rotation of a head portion of a user;
generating, on a basis of at least any one of the position and the rotation acquired at a first time, sound source data being ambisonics data in which a virtual sound source is represented through use of a spherical harmonic function in a virtual space having a predetermined position of the user as a center;
receiving at least any one of the position and the rotation updated at a second time after the first time;
applying correction processing including at least any one of a translation and a rotation of the virtual sound source in the virtual space to the sound source data at the first time on a basis of a difference of at least any one of the position and the rotation at the first time from at least any one of the updated position and rotation; and
generating a sound to be rendered through use of the sound source data to which the correction processing has been applied.

8. A non-transitory, computer-readable storage medium containing a computer program, which when executed by a computer, causes the computer to perform a sound generation method, comprising:
acquiring at least any one of a position and a rotation of a head portion of a user;
generating, on a basis of at least any one of the position and the rotation acquired at a first time, sound source data being ambisonics data in which a virtual sound source is represented through use of a spherical harmonic function in a virtual space having a predetermined position of the user as a center;
receiving at least any one of the position and the rotation updated at a second time after the first time;
applying correction processing including at least any one of a translation and a rotation of the virtual sound source in the virtual space to the sound source data at the first time on a basis of a difference of at least any one of the position and the rotation at the first time from at least any one of the updated position and rotation; and
generating a sound to be rendered through use of the sound source data to which the correction processing has been applied.
